(19) United States
(12) Patent Application Publication
(10) Pub. No.: US 2012/0150657 A1
(43) Pub. Date: Jun. 14, 2012

(54) Enabling Advertisers to Bid on Abstract Objects

(75) Inventors: Benjamin Rubinstein, Mountain View, CA (US); Ashok Chandra, Saratoga, CA (US); Olivier Dabrowski, Gilroy, CA (US); David James Gemmell, Danville, CA (US); Min-John Lee, Beijing (CN)

(73) Assignee: MICROSOFT CORPORATION, Redmond, WA (US)

(21) Appl. No.: 12/967,855

(22) Filed: Dec. 14, 2010

(51) Int. Cl. G06Q 30/00

(52) U.S. Cl. 705/14.66; 705/14.71

(57) ABSTRACT

Computer-readable media, computer systems, and computing methods are provided for employing abstract objects to solicit bids from advertisers and to present ads submitted by the advertisers upon a user invoking the abstract objects while conducting an online search. The abstract objects include entities, entity classes, actions, and tasks, which are mined by crawling storage locations on the Internet. These abstract objects are monetized by building an index with entries referencing the abstract objects and maintaining the index in a location accessible to advertisers. Via the index, the advertisers target the abstract objects and place bids thereon. During a user-initiated online search, the abstract objects that are relevant to a task being carried out by the user are identified. Further, ads submitted by advertisers that placed bids upon the identified abstract objects are selected for presentation. Based on the bids, the winning advertiser's ad is presented to the user.

### BACKGROUND

Current cost-per-click (CPC) advertising on conventional search engines is currently carried out by advertisers bidding a particular amount for search keyword(s). Thus, when a user enters a search for a particular keyword, such as “lawnmower,” an ad submitted by the advertiser placing the highest bid will typically be selected for presentation on the results page. This approach does not apply directly to task/decision engines, where users choose “entities” or “actions” and refine their intent over multiple steps.

Increasingly, users conduct searches to accomplish “tasks,” such as reserving a table at a restaurant, renting an online movie, purchasing a book, or booking a trip. These tasks can be performed in association with various entities (e.g., people, places, and things), various actions (e.g., buy, sell, rent, and the like), and various vendors. For instance, during the course of completing the task, the user's intent may be refined by the user performing one or more of the following actions: specifying parameters of an entity (e.g., cameras less than $200, flight to the location of San Francisco, or an original movie released in 2005 and not the 2009 remake); specifying an action related to the entity (e.g., renting as opposed to buying); and specifying a vendor.

When a user is working on a task, the advertisers may wish to show ads pertaining to a related or subsequent task. In one example, an advertiser may wish to present an ad for a service contract while a user is buying an electronic product from a website. In another example, an advertiser may wish to present an ad for making dinner reservations when the user has purchased movie tickets. However, presently, such intent refinement is not readily available for advertisers to bid upon. That is, the conventional search engines that accept bids for keywords are not designed for displaying an advertiser-submitted ad that corresponds to entities or actions that comprise a task being carried out by a user. This deficiency of conventional search engines results in both a poor user search experience and a failure of the search engine to optimally monetize a user's search.

### SUMMARY

This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

Embodiments of the present invention introduce various methods and search engines that attempt to monetize user intent by allowing advertisers to target abstract objects that reflect user-intent disambiguation choices. As an example, search verticals that include searched entities and/or executed actions are monetized by allowing advertisers to bid upon the entities and actions. In particular, an ad-entry UI is provided herein that facilities accepting advertisers' bids on “entities” being searched for by a user, as opposed to just keywords in a query, as well as “actions” relevant to those searched entities.

Typically, a user interacts with a search engine when conducting a search. During interaction, the user may perform a sequence of actions that informs the search engine about the user's true search intent (providing context to the initial query) and provides an understanding of the precise task the user is trying to perform. Also, the search engine may have a precognition regarding a specific entity the user is looking for during a search. The sequence of actions and the specific entity can be used to select advertisements. For instance, a user-initiated search for the specific entity (e.g., a restaurant) may trigger information relevant to the entity, such as a restaurant's location (e.g., street, city, and state), food type, price range, etc. As such, this relevant information may be made available for an advertiser to bid upon.

### BRIEF DESCRIPTION OF THE DRAWINGS

Embodiments of the invention are described in detail below with reference to the attached drawing figures, wherein:

FIG. 1 is a block diagram of an exemplary computing device suitable for implementing embodiments of the invention;

FIG. 2 is a schematic diagram depicting a first illustrative UI display that includes a representation of an abstract object being searched by a user and an ad corresponding to the abstract object, in accordance with embodiments of the invention;

FIG. 3 is a block diagram of an exemplary network environment suitable for use in implementing embodiments of the invention;

FIG. 4 is a schematic diagram depicting a second illustrative UI display that includes a representation of an abstract object being searched by a user and an ad corresponding to the abstract object, in accordance with embodiments of the invention;

FIG. 5 is a schematic diagram depicting a third illustrative UI display that includes a representation of an abstract object being searched by a user and an ad corresponding to the abstract object, in accordance with embodiments of the invention;

FIG. 6 is a schematic diagram depicting a fourth illustrative UI display that includes a representation of an abstract object being searched by a user and an ad corresponding to the abstract object, in accordance with embodiments of the invention;

FIG. 7 is a schematic diagram depicting a fifth illustrative UI display that includes a representation of an abstract object being searched by a user and an ad corresponding to the abstract object, in accordance with embodiments of the invention;

FIG. 8 is a schematic diagram depicting a sixth illustrative UI display that includes a representation of an abstract object being searched by a user and an ad corresponding to the abstract object, in accordance with embodiments of the invention;

FIG. 9 is a block diagram of an exemplary network environment suitable for use in implementing embodiments of the invention;

FIG. 10 is a schematic diagram depicting a seventh illustrative UI display that includes a representation of an abstract object being searched by a user and an ad corresponding to the abstract object, in accordance with embodiments of the invention;

FIG. 11 is a flow diagram depicting an illustrative method of monetizing abstract objects, in accordance with embodiments of the invention; and

FIG. 12 is a flow diagram depicting an illustrative method of allowing a first advertiser to bid on an abstract object targeted thereby, in accordance with embodiments of the invention.

### DETAILED DESCRIPTION

The subject matter of embodiments of the invention disclosed herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As can be gleaned from the disclosure below, various embodiments of the present invention pertain to monetizing abstract objects utilizing task-based engines (e.g., decision engines, task engines, individual applications or operations, applet systems, operating systems, and task-based mobile systems), or general systems that allow a user to execute tasks or applications by matching targeted abstract objects to user intent. For simplicity of discussion, these engines and/or systems will be hereinafter referred to as “search engines.”

Embodiments of the invention described herein include computer-readable media having embodied thereon computer-executable instructions. When executed, the computer-executable instructions perform a method for allowing an advertiser to bid on an abstract object targeted thereby. In embodiments, the method includes the step of crawling a network to mine abstract object(s). As defined below with greater particularity, the abstract object(s) describe a specific intent of a user when implementing a search event (e.g., shopping for an item online, reserving a flight and/or hotel room, or researching a particular location). Often, a search engine is used to distill the user's specific intent from a compilation of related user interactions with the search engine.

The method may additionally involve the steps of building an index with entries referencing the abstract object(s) and maintaining the index in a location accessible to advertisers. When the index is maintained in a location accessible to the advertisers, those advertisers are consequently allowed to view the entries of the index, target at least one abstract object from the index, and place a bid for the targeted abstract object. Once this “advertising campaign” is received from the advertisers, the bid may be stored in association with the targeted abstract object.

In a second illustrative embodiment, the present invention introduces a computer system for selecting an ad by employing and monetizing entities. Typically, the computer system includes computer software components comprising the following: an input-receiving component; a web-crawling component; a publishing component, an entity-matching component, a spot-auctioning component; and a rendering component. The input-receiving component is generally configured to detect interactions of users when implementing search events at a search engine. The web-crawling component is generally configured to mine the entities from a record of the detected user interactions. As more fully discussed below, “entities” each relate to a person, place, or thing represented by a particular online description. In addition, the web-crawling component may be capable of constructing and maintaining an index that lists the mined entities in some organizational or hierarchical manner. The publishing component may be provided to publish the index at an online location, thereby allowing advertisers to navigate to the index and to bid upon one or more of the entities therein. The publishing component may also receive bids in association with ads for display and temporarily store the bids in association with the ads.

In embodiments, the entity-matching component is configured to compile the user interactions at the search engine during a search event and to compare the compiled user interactions with the mined entities referenced by the index. The spot-auctioning component then selects one ad associated with the bids received at the publishing component. In an exemplary embodiment, selecting the ad comprises (a) identifying an entity from the index that matches the compiled user interactions upon comparison (using the entity-matching component), (b) identifying bids placed by the advertisers targeting the identified entity, and (c) selecting the ad from a plurality of ads associated with the identified bids. The rendering component presents the selected ad within a UI display. Typically, the selected ad is positioned within the UI display based upon a visual arrangement of related entities presented within the UI display.

In a third illustrative embodiment, a computerized method is provided monetizing abstract objects. In one instance, the method is carried out by a search engine running on a processor. Initially, the method involves the step of providing an index referencing one or more abstract objects. Typically, the abstract object(s) each describe a specific intent of a user when implementing a search event. As more fully discussed below, the specific intent may be distilled from a compilation of related user interactions with the search engine.

The method may further involve the steps of receiving a selection of abstract object(s) from the index, receiving a bid for the selected abstract object(s), and receiving user-interaction information upon the user conducting the search event at the search engine. Generally, the user-interaction information includes query string(s), selection-action(s) within a UI, user-profile capturing historic search behavior of the user, and/or query log capturing historic search behavior of a plurality of users. Often, the user-interaction information is matched against the selected abstract object(s). An amount of the bid for the selected abstract object(s) that are matched is charged and the charged amount is recorded for purposes of billing.

Having described an overview of embodiments of the present invention, an exemplary operating environment in which embodiments of the present invention may be implemented is described below in order to provide a general context for various aspects of the present invention.

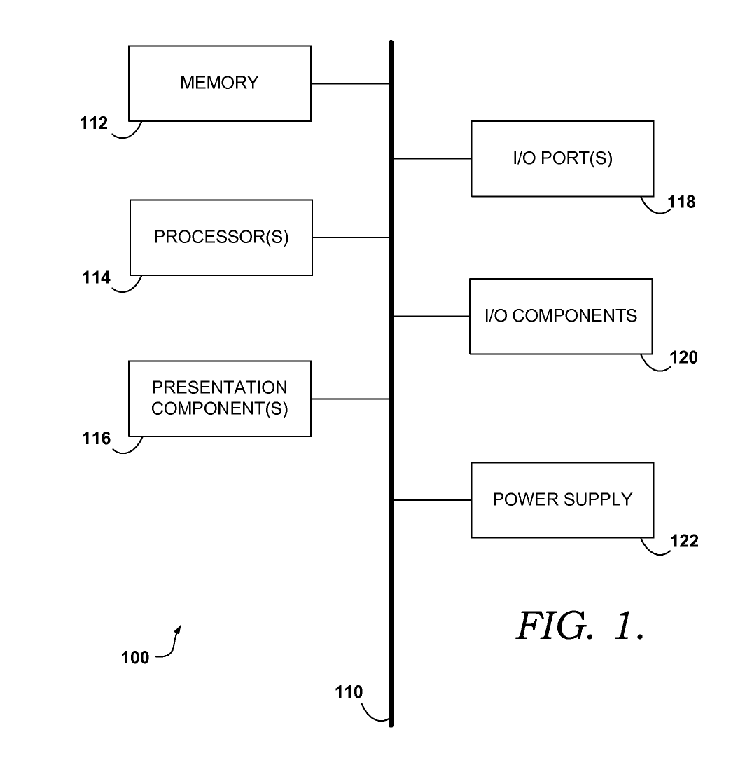

Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that performs particular tasks or implements particular abstract data types. The invention may be practiced in a variety of system configurations, including handheld devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and nonremovable media. By way of example, and not limitation, computer-readable media may comprise computer storage media and communication media. Computer storage media include both volatile and nonvolatile, removable and nonremovable media implemented in any method or technology for storage of information such as computer-readable instructions, data structures, program modules, or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium, which can be used to store the desired information and which can be accessed by computing device 100. Communication media typically embody computer-readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As mentioned above, embodiments of the invention employ a variety of techniques to help disambiguate user intent during a search event. One of these techniques involves determining the entity in which the user is truly interested. Upon distilling the search event into one or more entities, an advertiser is allowed to bid on those entities. Thus, the techniques described below help match advertiser bids with user intent such that the user-intent disambiguation techniques for making the match are sufficiently transparent to the advertiser.

Conventional search engines that accept the advertiser's bid(s) for keywords provide the advertiser with no knowledge of the choices being made by the search engine when placing ads submitted by the advertiser. As such, keywords may be triggered at times when the advertiser does not wish their ad to be displayed, or the ad is misapplied or irrelevant to the present search event. This inefficient situation becomes compounded when a multistep task is executed in particular phases that may not initially appear related to one another or to a particular keyword. As such, using entities and other abstract objects, as opposed to keywords, allow advertisers to better understand the context in which their ads will be placed.

Embodiments of the present invention are directed to employing one or more abstract objects to solicit advertisement bids and to invoke the presentation of selected advertisements that correspond with the abstract object(s) presently occurring during a search. In particular, the embodiments of the invention provide a system and method for allowing advertisers to target abstract objects, thus, leading to the monetization of (a) surfaced entities within a results page, (b) search-engine detected entity actions, or (c) tasks being carried out as a result of user interaction with the search engine. Generally, these “abstract objects” operate as actionable tasks, actions, and/or entities that cannot be adequately managed through keywords. That is, abstract objects consider the context of a user's search event, which exposes the user's true intent, as opposed to employing just keyword-matching techniques, which do not always target the user's intent. Often, the abstract objects may include, but are not limited to, the following: entities, entity classes, entity actions, tasks, and vendors.

As used herein, the term “entities” generally refers to logical objects that may be represented by a particular online description. These logical objects may be a person, place, thing, or any combination thereof. For instance, some examples of logical objects are the following: the movie Avatar released in 2009; the restaurant Shiva's on Castro Street in the city of Mountain View, Calif.; the CEO of Microsoft™, Steve Ballmer; the Alaska Airlines' flight #AS331 from San Jose to Seattle; and the Canon PowerShot™ A3100 IS digital camera.

Typically, entities may be listed within an index or may be referenced by entries within the index. In embodiments, the index may represent entities by a description (e.g., Canon PowerShot™ A3100 IS digital camera), by an identifier from a well-known company (e.g., tag identifier), by a uniform resource identifier (URI), or a uniform resource locator (URL). For example, a movie could be identified by the URL(s) pointing to one or more websites, such as websites owned by Internet Movie Database (IMDb), AMC Entertainment, or Netflix. As such, the 2009 blockbuster movie Avatar for sale by IMDb may be represented by a particular URL “http://www.imdb.com/title/tt0499549/,” which navigates to the IMDb web site while referencing Avatar.

In practice, an advertiser may wish to target a particular movie, for example, rather than another movie, book, or other product with a similar name. Such an advertiser could do so by specifying the example URL above. Upon specifying the example URL, the search engine would identify the appropriate advertiser based on user intent. That is, the search engine would identify the advertiser specifying the URL above upon the user navigating to the IMDb website while referencing the movie Avatar. In the instance where the user is actually interested in the Avatar restaurant in Sausalito, Calif., which may be represented by the particular URL “http://www.yelp.com/biz/avatars-restaurant-sausalito,” the search engine would avoid placing a movie ad submitted by the advertiser wishing to target the particular movie on the URL immediately above. Advantageously, the use of URL's as entities precludes selecting irrelevant ads for presentation, thereby enhancing the search experience for the user and, potentially, increasing the monetization opportunities of a search event.

Although various different examples of how entities may be represented are described above, it should be understood and appreciated that other types of suitable identifiers that represent entities may be used, and that embodiments of the present invention are not limited to those identifiers (e.g., URL's) described herein. For instance, entities may be specified by, but not limited to, the following identifiers: universal product codes (UPC), latitude and longitude coordinates of a location, and street address of a location. Such examples of entities and their identifiers are numerous, as there is much ambiguity to account for within search keywords.

Another type of abstract object used to monetize a search event are “entity classes,” which generally refer to a set of entities that share a common property. For example, “entity classes” include sets of entities grouped by one or more shared properties or parameters, such as movies; movies with “Avatar” in their title; all movies directed by James Cameron; restaurants located on Castro Street in Mountain View, Calif.; Indian restaurants in Mountain View; CEOs of Fortune 500 companies; flights from San Jose to Seattle; electronics products; digital cameras; and digital cameras under $200.

In operation, when the user intent during a search event points to an entity class, those specific entities targeted by advertisers within the purview of the entity class would be matched to the search event. Embodiments of the present invention further allow advertisers to target entity classes when bidding for advertising space. For example, an advertiser may target “Restaurants in Mountain View, Calif.,” as listed above. Subsequently, when a user enters a search query that references the restaurant Shiva's, which is located in Mountain View, Calif., the search engine would likely identify a match between this search query and the advertiser's targeted entity class. In another example, if a user that is located proximate to the city of Mountain View (known by examining a user-profile associated with the user) enters a search query for “restaurant,” the search engine may make a match to the entity class “Restaurants in Mountain View, Calif..”

In yet another example, an advertiser may target the entity class “digital cameras under $200” when placing a bid and submitting an ad to be displayed upon that entity class being matched. Subsequently, if a user enters a search query including the phrase “cheap digital cameras,” the search engine may elect to match the targeted entity class “digital cameras under $200” with the search query. Consequently, the search engine may select and display the advertiser's submitted ad that corresponds with the user's true search intent (i.e., particular price range for a product) as opposed to rigid keyword matching, which could generate irrelevant ads that relate to sales or temporary discounts.

Often, entity classes may be categorized by some criteria to form entity domains. These “entity domains” are general groupings covering a wide scope of entities and serve as general divisions between the entity classes. For example, entity domains may include, but are not limited to, the following examples: cars, movies, businesses local to the user, transportation, and electronics. Accordingly, entity domains represent the highest-level classifier of entities within the hierarchy of entity domains, entity classes, and individual entities.

Inherent to many entity domains are entity actions. As used herein, the phrase “entity actions” is not limited to any particular actions, but broadly refers to one or more online actions a user performs via user interactions with a search engine. Often, entity actions address an entity and/or an entity class. By way of example, in the movie domain, some exemplary entity actions may include the actions of buy, rent, stream, watch trailer, read reviews, and book tickets. When conducting a search event, a user may apply one or more of these entity actions to entities (e.g., the movie Avatar) or to entity classes (e.g., all movies directed by James Cameron). In another example, in the local-to-the-user domain, some exemplary entity actions may include the actions of make reservation, read menu, or map directions. When conducting a search event, a user may apply one or more of these entity actions to entities (e.g., the restaurant Shiva's) or to entity classes (e.g., restaurants in Mountain View).

A sequence of entity actions that are implemented within a search event may combine to form a higher-level task, such as plan night out, check stock quotes, order take-out, or plan vacation. As used herein, the term “task” relates to high-order concepts that describe the aggregate sum of multiple steps (e.g., searching entities, taking entity actions, and the like) performed by a user during a search event. As such, tasks represent a single semantic representation that captures the implicit meaning of a plurality of natural-language search queries and/or entity actions issued by the user. Typically, the search engine is capable of determining a relationship between the queries and actions, as well as distilling the common attributes of the queries and actions, thereby focusing upon an overarching task being performed by the user. One example of a sequence of entity actions that may be defined by a task is a search vertical. In one instance, the phrase “search vertical” may refer to the narrowing or refinement of a search query using some parameters that were not originally present within the search query. For instance, these additional parameters may include additional search terms added to the query or selections of links within a set of search results.

The idea of search verticals can be applied to other types of searches beyond queries. In one instance, a search vertical may relate to an image vertical, that involves searching for many common entity pictures. In another instance, a search vertical may relate to a map vertical, that involves searching for a location within a map by drilling down through zoom levels or by scrolling a particular grid section of a map. Advantageously, these search verticals, as well as others not mentioned, allow advertisers to target various tasks that would not be available using merely keywords.

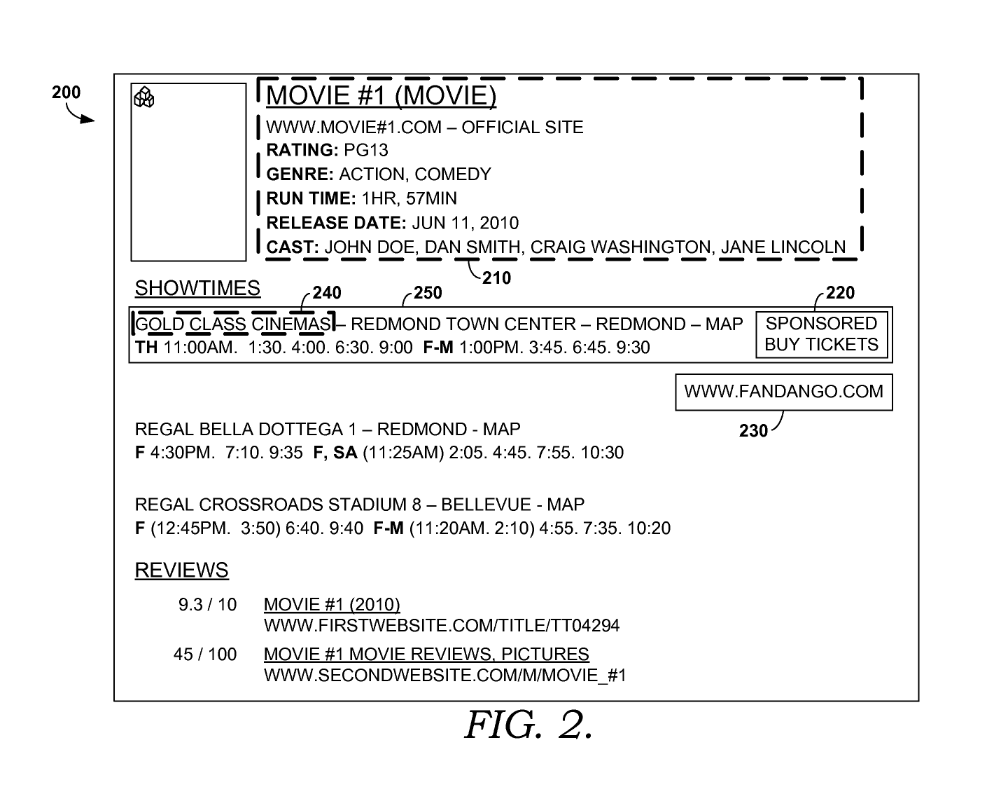

Turning now to FIG. 2, an illustrative representation of ads, entities, entity classes, and entity actions will now be discussed. Generally, at FIG. 2 a schematic diagram is shown depicting an illustrative UI display 200 that includes a representation of abstract objects being searched by a user and an ad corresponding to one of the abstract objects, in accordance with embodiments of the invention. As can be seen, the UI display 200 is a movie-listing web page for “movie #1.” This web page may have been reached by a user entering a search query including the phrase “currently playing movies,” and then selecting a link within the search results that were generated in response to executing the search query. The phrase “search query,” as used herein, generally refers to any type of request containing one or more search terms or phrases that can be submitted to a search engine (or multiple search engines) for identifying search results based on the content contained within the search query. The search results that are identified by the search queries may be reformatted representations of results produced in response to the search queries. For example, the search results can be instant answers, advertisements, images, and other relevant items.

The UI display 200 includes a header 210 that provides detailed information about the “movie #1.” Further, the highest-ranked theater location 240 and venue/show-time information 250 is highlighted. This ranking and highlighting may be based on which theater is most local to the user conducting the search event (e.g., based on known location information of the user via a user profile). An interface element 220 of “buy tickets” may be presented to the user for facilitating the purchase of passes to “movie #1” at the most local theater via an advertiser. This interface element 220 (e.g., link, anchor, or hyperlink) may be an ad that is placed (e.g., inserted into a sponsored zone) on the UI display 200 as a result of the processes described below. Further, a link 230 for a ticket retailer (advertiser) may be displayed by the search engine in a position proximate to the interface element 220 in order to compete with sales information customarily displayed within the UI display 200 and to provide context for the interface element 220. As can be seen, the label “sponsored” sets apart the interface element 220 from the rest of the content of the web page surfaced on the UI display and signifies that the entity action associated with the interface element 220 is an ad. In other embodiments, the interface element 220 may be distinguished from the web-page content by applying a coloring or highlighting to the interface element 220.

In one embodiment, the sponsored interface element 220 is presented as a result of an advertiser submitting an ad and targeting an abstract object for triggering the ad. For instance, the advertiser (Fandango™) may have targeted “movie #1” as the entity where they would like their ad displayed. As discussed above, the user's search vertical may have included a general query for “currently playing movies” and a selection of a link within the search results. As such, a keyword-based search engine would not have matched the ad with the UI display 200. Yet, techniques introduced by the present invention allow for aggregating the queries and actions that a user has taken during a search event (i.e., search vertical) and deciphering the user's true intent. In this case, the user's true intent was to see the “movie #1.” Upon recognizing “movie #1,” the search engine may then match the entity representing “movie #1” and select ads from advertisers that targeted “movie #1,” such as the ad from the advertiser Fandango. Accordingly, a high correlation between the user's intent and the ad selected for display may be maintained using abstract objects in place of conventional keyword-matching mechanisms.

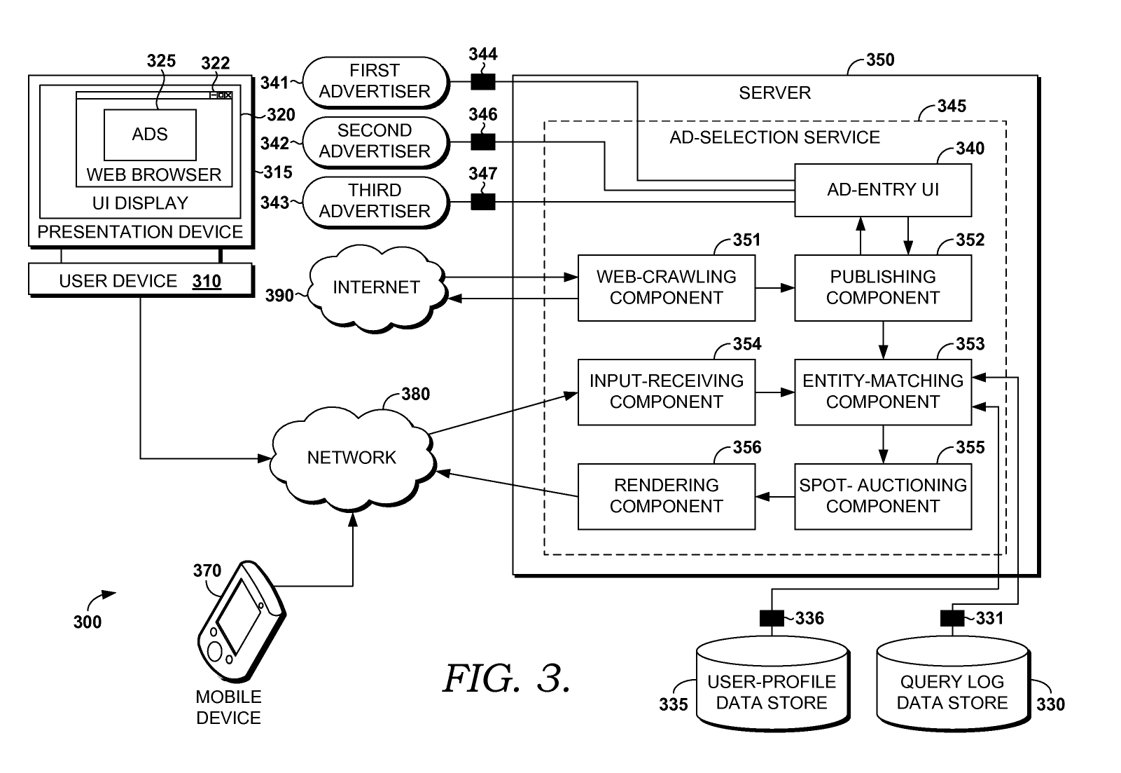

The system architecture for implementing the method of monetizing user-conducted search events by employing abstract objects will now be discussed with reference to FIG. 3. Initially, FIG. 3 is a block diagram illustrating a distributed computing environment 300 suitable for use in implementing embodiments of the present invention. The exemplary computing environment 300 includes a user device 310, data stores 330 and 335, a web server 350, a mobile device 370, and a network 380 that interconnects each of these items. Each of the user device 310, the data stores 330 and 335, the server 350, and the mobile device 370, shown in FIG. 3, may take the form of various types of computing devices, such as, for example, the computing device 100 described above with reference to FIG. 1. By way of example only and not limitation, the user device 310, the server 350, and/or the mobile device 370 may be a personal computer, desktop computer, laptop computer, consumer electronic device, handheld device (e.g., personal digital assistant), various servers, processing equipment, and the like. It should be noted, however, that the invention is not limited to implementation on such computing devices but may be implemented on any of a variety of different types of computing devices within the scope of embodiments of the present invention.

Typically, each of the user device 310, the server 350, and the mobile device 370 includes, or is linked to, some form of a computing unit (e.g., central processing unit, microprocessor, etc.) to support operations of the component(s) running thereon (e.g., web-crawling component 351, publishing component 352, entity-matching component 353, input-receiving component 354, spot-auctioning component 355, rendering component 356, and the like). As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the user device 310, the server 350, and the mobile device 370 in order to enable each device to perform communication-related processes and other operations (e.g., employing the ad-selection service 345 to access the user-profile data store 335 and/or the query log data store 330 to filter advertisements based on user behavior). In another instance, the computing unit may encompass processor(s) (not shown) coupled to the computer-readable medium accommodated by each of user device 310, the server 350, and the mobile device 370.

Generally, the computer-readable medium includes physical memory that stores, at least temporarily, a plurality of computer software components that are executable by the processor. As utilized herein, the term “processor” is not meant to be limiting and may encompass any elements of the computing unit that act in a computational capacity. In such capacity, the processor may be configured as a tangible article that processes instructions. In an exemplary embodiment, processing may involve fetching, decoding/interpreting, executing, and writing back instructions.

Also, beyond processing instructions, the processor may transfer information to and from other resources that are integral to, or disposed on, the user device 310, the server 350, and the mobile device 370. Generally, resources refer to software components or hardware mechanisms that enable user device 310, the server 350, and the mobile device 370 to perform a particular function. By way of example only, resource(s) accommodated by the web server 350 operate to assist the ad-selection service 345 in selecting ads upon matching targeted abstract objects to the user intent of a search event.

The user device 310 may include an input device (not shown) and a presentation device 315. Generally, the input device is provided to receive input(s) affecting, among other things, search results and advertisement(s) 325 rendered by a web browser 322 surfaced at a UI display 320. Illustrative input devices include a mouse, joystick, key pad, microphone, I/O components 120 of FIG. 1, or any other component capable of receiving a user input and communicating an indication of that input to the user device 310. By way of example only, the input device facilitates entry of a search query that indicates to the ad-selection service 345 that an opportunity to present advertisement(s) 325 exists.

In embodiments, the presentation device 315 is configured to render and/or present the UI display 320 thereon. The presentation device 315, which is operably coupled to an output of the user device 310, may be configured as any presentation component that is capable of presenting information to a user, such as a digital monitor, electronic display panel, touch-screen, analog set-top box, plasma screen, audio speakers, Braille pad, and the like. In one exemplary embodiment, the presentation device 315 is configured to present rich content, such as the advertisement(s) 325 and digital images. In another exemplary embodiment, the presentation device 315 is capable of rendering other forms of media (i.e., audio signals).

The data stores 330 and 335 are generally configured to store information associated with user-interaction information. In operation, when the user is implementing a search event at the search engine, the search engine may access the user-interaction information, such as a query string within a search query entered during the search event, a selection-action within a UI display, a user-profile 336 (capturing historic search behavior of the user) at the user-profile data store 335, or query log 331 (capturing historic search behavior of a plurality of users) at the query log data store 330. The advertisement(s) 325 that are displayed may be selected or filtered by the ad-selection service 345 (e.g., AdCenter) based on, in part, the user-interaction information.

In various embodiments, such user-interaction information may be supplied by third-party services who are partners of the ad-selection service 345, or may be dynamically tracked and recorded/analyzed by a search engine in communication with the ad-selection service 345. In other embodiments, the data stores 330 and 335 may be configured to be searchable for suitable access to the stored user-interaction information. For instance, the data stores 330 and 335 may be searchable for data concerning a group of users (e.g., query log 331) or data targeted toward interests of a specific user (e.g., user profile 336). It will be understood and appreciated by those of ordinary skill in the art that the information stored in the data stores 330 and 335 may be configurable and may include any information relevant to the storage and/or retrieval of the user-interaction information. The content and volume of such user-interaction information are not intended to limit the scope of embodiments of the present invention in any way. Further, though illustrated as single, independent components, the data store(s) 330 and 335 may, in fact, be a plurality of databases, for instance, a database cluster, portions of which may reside on the client device 310, the server 350, the mobile device 370, another external computing device (not shown), and/or any combination thereof.

This distributed computing environment 300 is but one example of a suitable environment that may be implemented to carry out aspects of the present invention and is not intended to suggest any limitation as to the scope of use or functionality of the invention. Neither should the illustrated distributed computing environment 300 be interpreted as having any dependency or requirement relating to any one or combination of the devices 310, 350, and 370, the storage devices 330 and 335, and components 351-356 as illustrated. In some embodiments, one or more of the components 351-356 may be implemented as stand-alone devices. In other embodiments, one or more of the components 351-356 may be integrated directly into the server 350, or on distributed nodes that interconnect to form the server 350. It will be appreciated and understood that the components 351-356 (illustrated in FIG. 3) are exemplary in nature and in number and should not be construed as limiting.

Accordingly, any number of components may be employed to achieve the desired functionality within the scope of embodiments of the present invention. Although the various components of FIG. 3 are shown with lines for the sake of clarity, in reality, delineating various components is not so clear, and, metaphorically, the lines would more accurately be grey or fuzzy. Further, although some components of FIG. 3 are depicted as single blocks, the depictions are exemplary in nature and in number and are not to be construed as limiting (e.g., although only one presentation device 315 is shown, many more may be communicatively coupled to the client device 310).

Further, the devices of the exemplary system architecture may be interconnected by any method known in the relevant field. For instance, the user device 310, the server 350, and the mobile device 370 may be operably coupled via a distributed computing environment that includes multiple computing devices coupled with one another via one or more networks (not shown). In embodiments, the network may include, without limitation, one or more local area networks (LANs) and/or wide area networks (WANs). Such networking environments are commonplace in offices, enterprise-wide computer networks, intranets, and the Internet. Accordingly, the network is not further described herein.

In operation, the components 351-356 are designed to perform a process that includes, at least, automatically selecting one or more advertisements 325 for display by a web browser 322 that are relevant to a user's intent when conducting a search event. As a result, the process performed by the ad-selection service 345 (i.e., portion of a search engine) can monetize various abstract objects (e.g., entities surfaced in a search-results page, queried entity classes, one or a sequence of detected entity actions, pending/completed tasks, or a person, place, or thing represented by a particular online description), which capture various user intents, in a way that keyword-type search engines cannot. Initially, the ad-selection service 345 includes a web-crawling component 351 that mines the abstract objects from a record of the user interactions. In one instance, the user interactions may be mined by inspecting real-time interactions of users with a web (e.g., private enterprise intranet, Internet 390, extensive ad marketplaces, and other networks). By way of example, the web-crawling component 351 may extract user interactions by deep crawling data stores interconnected via the web. This may involve deep crawling the data stores 330 and 335 to access and aggregate the user-interaction information stored therein.

Generally, the process of mining abstract objects via web crawling is performed offline in order to construct and maintain an index that lists the mined abstract objects. In embodiments, the index is built with entries that reference the mined abstract objects. In addition, the index may be stored in a location accessible to advertisers 341, 342, and 343, thereby allowing them to view the entries of the index.

In an exemplary embodiment, the web-crawling component 351 is configured with some intelligence such that it might continuously or intermittently (e.g., at predetermined periods of time) update the index. For instance, this intelligence may interpret human-generated actions to understand what users are currently doing online, such as what tasks are most popular. In another instance, this intelligence may dynamically monitor user-interaction information (e.g., user profile 336 and query log 330) to understand frequent/current search behavior and perceive trends therein. Eventually, upon interpreting human-generated actions and monitoring user-interaction information, the intelligence of the web-crawling component 351 may automatically add or drop abstract objects from the index without human intervention, typically, when detected behavior meets some predetermined criteria. By way of example, the web-crawling component 351 may automatically add to the index common entity actions taken in relation to a certain entity class. In another example, the web-crawling component 351 may process prior search queries and click logs to estimate the likelihood of future clicks, thereby estimating the quality and relevance of abstract objects. When the quality or relevance of an abstract object falls below a defined threshold, the abstract object is reconfigured or simply eliminated from the index.

This task of exposing the index in an online location to the advertisers 341, 342, and 343 is typically performed by the publishing component 352 via an ad-entry UI 340, which serves as an interface between the ad-selection service 345 and the advertisers 341, 342, and 343. In one instance, the ad-entry UI 340 functions to publish the index to the advertisers 341, 342, and 343 so that they may navigate an organized listing of abstract objects. In another instance, the ad-entry UI 340 functions to receive selections within the index that target abstract objects or ad hoc keyword entries that are associated with abstract objects. Upon targeting one or more abstract objects, the advertisers 341, 342, and 343 may place bids 344, 346, and 347, respectively, upon the targeted abstract objects. These bids 344, 346, and 347 may be associated with ads submitted by the advertisers 341, 342, and 343. These ads (e.g., advertisements 325) may be displayed by the web browser 322 when targeted abstract object(s) match a user intent ascertained from a search event and when one or more of the advertisers 341, 342, and 343 wins a spot auction, which weighs the values of the bids 344, 346, and 347 among other considerations.

The following discussion pertains to ways that advertisers may target abstract objects within the ad-entry UI when placing bids for spot auctions and is not to be construed as limiting to any particular embodiment below. Initially, targeting may involve an advertiser specifying various entities, entity classes, actions, tasks, or any combination thereof, that the advertiser desires to show its ad(s) in correlation with. In one instance, advertisers can bid on entities by specifying an entity description, such as a URL, where a match occurs when the specified URL is displayed or selected on a search results page. Specifying a URL may involve selecting predefined options within the ad-entry UI 340. For example, the advertiser may select a “primary source,” such as manufacturer or service provider (e.g., Netflix for movies or Amazon for shopping) and/or a “secondary source,” such as a manufacturer's entity page (e.g., the Canon site for a specific Canon camera), the advertiser's own web page representing the entity (e.g., the Netflix page on the “Avatar” movie by James Cameron, from which members can rent or stream said movie), and a reservation/purchase page for the entity (e.g., Open Table's page for Shiva's restaurant in Mountain View from which table reservations can be made). In this way, the ad-entry UI 340 allows an advertiser to select components or blocks (e.g., primary source and secondary source) that make up a URL, while the search engine acts to identify the actual corresponding URL used for entity matching. That is, the search engine may automatically find the different URLs that match a certain entity (e.g., Canon digital camera) specified by the advertiser in a transparent manner using any available technique, such as an entity-matching algorithm.

Although various different methods for targeting entities have been described, it should be understood and appreciated that other types of suitable methods and interfaces for selecting an entity and placing a bid thereon may be used, and that embodiments of the present invention are not limited to those methods for transforming a selection or input of an entity into a URL described herein. For instance, advertisers may target an entity by specifying a UPC code, a product's serial number, a business's street address, a location's longitude/latitude pair, or some other domain-specific identifier for the targeted entity.

In other embodiments, advertisers can target entity classes by way of a variety of techniques. By way of example, advertisers may specify entity classes by the technique of specifying a domain (e.g., movies, shopping, travel, etc.) and then specifying keywords that refine the entities from within the specified domain (e.g., “cameras,” “sci-fi movies,” “flights to Australia from San Francisco,” etc.). In another example, advertisers may specify entity classes by specifying a domain and then specifying parameters that point to attributes (e.g., “Canon cameras,” “sci-fi movies by Ridley Scott,” “five-star hotels in Sydney,” etc.) of particular entities with entity classes. In yet another example, advertisers may target entity classes by browsing a “directory” of the index that lists the predefined entities and/or entity classes (the directory exposes the predefined entities and/or entity classes as selectable options) and specifying the desired entities and/or entity classes from the directory.

In embodiments, to target entity actions, advertisers may employ the ad-entry UI 340 to specify their choice of entities, entity classes, or tasks, entity actions that they wish to target. In one instance, the directory of the index allows the advertisers to look up all search-engine-defined popular or recent entity actions (e.g., rent, buy, and stream) that users have commonly/frequently invoked in association with an entity, entity class, or task. For example, the popular entity actions that may appear when looking up the entity class “movies directed by James Cameron” may include “rent,” “buy,” or “bid” entity actions. These entity actions may be generally targeted for all movie-entities within James Cameron's catalog or specifically targeted for certain movies the advertiser currently offers or wishes to market. For instance, if the advertiser is represented by a retailer of movies and other entertainment goods, the advertiser might target the entity action of “sell” while, at the same time, specifying just those movies that are presently held in inventory. In operation, upon targeting the entity action, those bids placed by the advertiser on the targeted entity action are considered upon the targeted entity action matching the user intent or user selection actions of a search event.

In other embodiments, the ad-entry UI 340 may be employed to allow advertisers to target tasks. Typically, targeting tasks may be carried out in a similar way as entity class targeting, where the advertiser simply specifies keywords related to attributes of tasks, such as plan a vacation. In another embodiment, targeting tasks may be advertiser-defined. For instance, a task may be defined by the advertiser as being invoked upon one or more criteria being satisfied by the user activity occurring during a search event. In one example, an advertiser-defined task of “plan a night in” may be established as being invoked when both the entity actions of “rent movie” and “order home delivery of food” are satisfied. Accordingly, it should be understood and appreciated that advertisers may specify a single step (e.g., entity action or search query entry), multistep activities (e.g., tasks), intermediate steps of a task (e.g., entity classes), or any combination thereof when targeting abstract objects for their advertisement campaigns.

Consequently, the rates paid by the advertisers may vary in accordance with the number and specificity of the abstract objects that are targeted. In one instance, bids accepted for targeting a precise advertiser-defined task may be greater than bids accepted for targeting a broad search-engine-defined entity class. However, although a specific example of setting rates for targeting abstract objects has been described, it should be understood and appreciated that other types of suitable pricing schemes may be used, and that embodiments of the present invention are not limited to increasing bid amounts in parallel with increased abstract object specificity.

Beyond targeting just abstract objects, the ad-entry UI may be employed to allow advertisers to specify contextual information of the user (e.g., location of the user, time of the search event, demographics of the user, and other environmental variables) to condition the targeted abstract object(s). For example, an advertiser may target the task “plan a night in,” but condition the task being invoked upon the user residing in Mountain View, Calif., because the advertiser's goods or services are local to the user. In other embodiments, the contextual information may refer to information about a competitor, a plurality of users, third-party entities, and the like. Further, beyond specifying contextual information in concert with targeting abstract object(s), the publishing component 352 allows advertisers to target any combination of entities, entity classes, tasks, entity actions, and traditional keyword-based triggers. Even further, advertisers may be allowed to target other parameters that narrow an entity, entity class, entity action, or task, such as a vendor (e.g., competitor) selling the entity. In this instance, specific ads (e.g., offering special promotions aimed at potential customers) may be designated for being displayed in association with a competitor's web page, while other ads (e.g., offering incentives to current customers), which are targeted to the same entity, may be designated for being displayed in association with the advertiser's own web page.

Upon the bids 344, 346, and 347 being placed by the advertisers 341, 342, and 343, respectively, the bids 344, 346, and 347 are received by the publishing component 352. The publishing component facilitates temporary storage of the bids 344, 346, and 347 in association with submitted ads and targeted abstract objects and sometimes in association with an indicia of the advertisers 341, 342, and 343 responsible for targeting the abstract objects. The stored associations of the targeted abstract objects, bid(s), advertiser(s), and/or ads may reside in one or many locations, such as the server 350 or a remote data store (e.g., ad-campaign database).

The input-receiving component 354 is generally configured to detect interactions of users when implementing search events at the search engine. As used herein, the phrase “search event” is meant to be limiting, but encompasses any form of online search activity that is conducted by one or more users. In an exemplary embodiment, a search event may comprise a user searching the web (e.g., the Internet 390) for one or more related items over a predefined time frame. By way of example, a search event may include a user of the user device 310 or the mobile device 370 searching the network 380 for airlines, taxis, and hotels associated with a common city over the course of an abbreviated temporal span, such as a few days. In another example, a search event may occur during a single online session, where a user is researching and, eventually, purchasing a product.

Upon detecting interactions of the user with a search engine, the input-receiving component 354 can analyze the user interactions to recognize, deduce, and extract abstract objects therefrom. In embodiments, analyzing user interactions may involve monitoring a user's online navigation to detect actions implemented by the user and search queries entered by the user. Extracting abstract objects, in one instance, may involve compiling the actions and search queries into search verticals (e.g., shopping for various products) and attempting to pair one or more abstract objects (e.g., tasks) with the search vertical based upon the content therein. In another instance, extracting abstract objects from a search event may involve comparing search queries or selected links with predefined URLs (e.g., entities) to determine if a match occurs. In yet another instance, extracting objects may involve examining the context of the actions implemented by the user to determine whether the user actions correspond with predefined entity actions. Accordingly, extracting abstract objects may be a single-step or multistep process that may be extended over one or more sessions. Upon extracting one or more abstract objects from the user's search event, they are fed to the entity-matching component 353 for monetization.

The ad-selection service 345 portion of the search engine may also include the entity-matching component 353 that is generally configured to compile the user interactions (deducing abstract objects from a search event) at the search engine during a search event and to compare the compiled user interactions with the mined and/or targeted abstract objects. In instances, as discussed above, the input-receiving component 354 may be responsible for deducing abstract objects and, as such, discussion of this process will not be repeated.

The process of comparing the deduced abstract objects with the mined abstract objects of the index to find a match will now be explained. Advantageously, the comparison process matches user intent (i.e., inferred from search-query entry and/or user-initiated selections during a search event) with abstract objects, such that ads associated with the matched abstract objects may be displayed in a relevant position on a relevant web page, as more fully discussed below. Initially, in embodiments, the comparison process is performed online and dynamically during a search event while, in contrast, the process of deducing abstract objects is typically performed offline. It will be appreciated and understood that various mechanisms for matching deduced abstract objects from the input-receiving component 354 and targeted abstract objects from the publishing component 352 may be employed by the entity-matching component 353, such as entity resolution or record linkage.

In an exemplary embodiment, the comparison process is carried out in a substantially continuous manner. Accordingly, the matching targeted abstract objects are indentified in real-time, allowing the appropriate ads to be displayed as the user is navigating from web page to web page. For example, when a user selects a link that points to a particular URL, the entity-matching component 353 may search for an entity corresponding to that particular URL. If a match is realized for the particular URL, the entity-matching component 353 may then identify the advertisers that targeted the URL-entity and access the bids placed by the identified advertisers for the URL-entity. These accessed bids may be communicated to the spot-auctioning component 355 for determination of the winning advertiser(s).

In one embodiment, the comparison process involves matching based on user interactions that have been conducted during a search event plus likely subsequent user interactions (“expected actions”) that are anticipated in the near future. For example, a user may enter a search query for “status for flight no. 331” when looking for a flight from San Jose to Seattle. Current keyword-based systems would find no sensible advertisements that match such a search query. However, by employing the comparison process, the entity-matching component 353 can infer the proper user intent, and can anticipate the next steps, or expected actions, in the search event, which could include “limousines in Seattle,” “restaurants in Seattle,” or “hotels in Seattle.” Consequently, the entity-matching component 353 could match relevant tasks (e.g., plan a Seattle trip), entities (e.g., luxury hotels in Seattle), and/or entity classes (e.g., flights into Seattle over $300) to the initial search query. Accordingly, expected actions allow an advertiser to submit an ad in association with a targeted abstract object that is not directly related to the deduced abstract object. For instance, a vendor may bid to show their ad for taxi services when the deduced task relates to booking a certain hotel.

Upon executing the comparison process and communicating the matched targeted abstract objects to the spot-auctioning component 355, the spot-auctioning component 355 carries out a process for selecting one or more ads associated with a respective bid received at the publishing component 352 for display to a user, such as at the presentation device 315 or a graphical user-interface (GUI) display of the mobile device 370. As used herein, “bids” represent a contract that an advertiser will pay the search engine a certain amount should the ad be displayed to a user, clicked-on by a user, result in a purchase, etc., upon the advertiser winning a spot auction at the time of the search event.

In an exemplary embodiment, the ad-selection process generally involves the following steps: identifying abstract(s) object from the index that match the user intent, as communicated from the entity-matching component 353; identifying bids placed by one or more of the advertisers targeting the identified abstract objects; and selecting at least one ad from a plurality of ads associated with the identified bids. Often, selecting ad(s) based on, in part, the identified bids involves running a spot auction. The spot auction relies on various criteria for determining the best ad(s). In one instance, the spot auction relies on, but is not limited to, one or more of the following criteria to determine the best ad(s): expected revenue in accordance with the bid values; quality or relevance of the ad in the context of the user intent and/or the user profile (i.e., content of web page corresponds to the ad's claim); and likelihood of click-through (i.e., not a misleading link).

In other embodiments, the best ad(s) are determined by ranking the bids in decreasing order via some fixed function (e.g., profit maximization as a strict function of bid value) and selecting a predefined number of ads from the top-ranked bids for display. In one instance, the predefined number of ads is dependent upon a size of the user interface elements that expose the ads in light of available space allocated for ads on a web page, as described below. Once the ads are selected and displayed, the advertisers submitting the ads may be charged their bid amounts upon a user clicking on the ads. In another instance, a Vickrey-type price auction may govern the amount that an advertiser submitting a clicked-on ad will be charged. Any other auction mechanism is possible too, as well as bulk ad sales. For example, a new vendor for movie rentals may target every “rent” or “stream” action on a movie-entity at the search engine, all for a fixed price over a month. Or, in another example, the same vendor may target a competitor, like Netflix, so that whenever a Netflix entity action is perceived by the search engine, the new vendor may be charged per placement of an ad on the Netflix website. It should be understood and appreciated, while embodiments of the present invention are described herein in terms of auction-based ad placement, as in cost-per-click (CPC) advertising, other embodiments of the present invention may encompass other ad-placement mechanisms applicable to publisher- or advertiser-targeted ad sales.

Finally, the ad-selection service 345 may comprise a rendering component 356 for presenting the selected ad(s) as UI elements within a UI display (e.g., the UI display 320) based upon a visual arrangement of items on the UI display. Initially, any one of a number of types of “interface elements” may be employed to display the selected ads. In one embodiment, the type of interface element employed for displaying a selected ad depends, in part, on how items (e.g., entity actions) are displayed on the UI display, thereby allowing the rendering component 356 to provide richer and more relevant content on each web page of a search event.

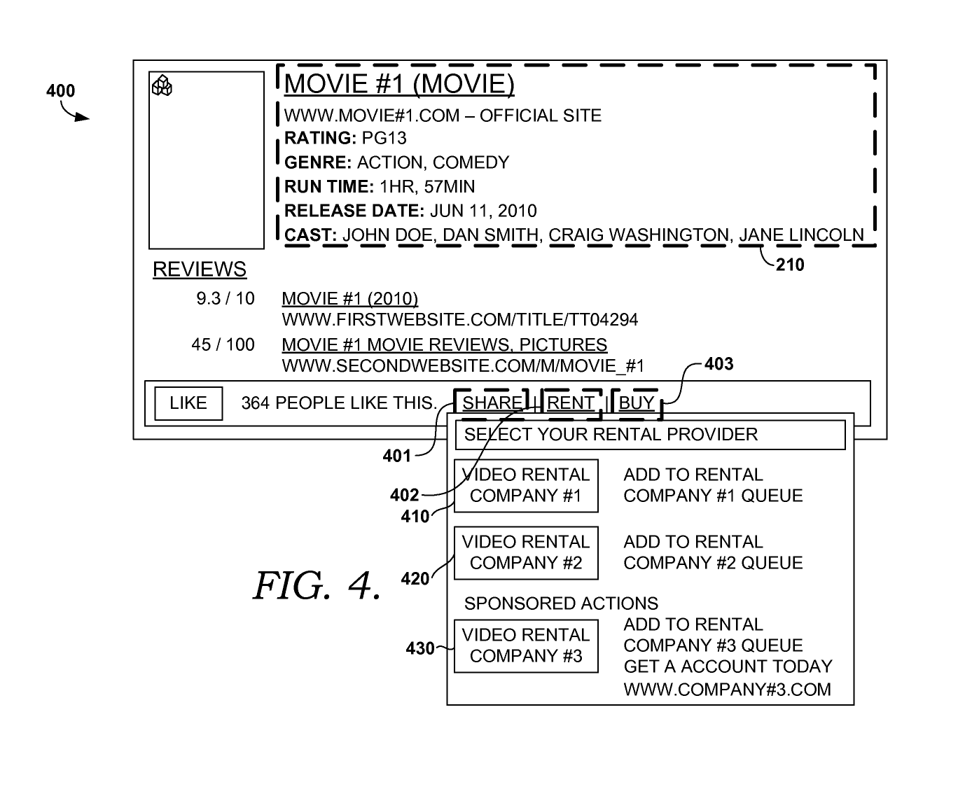

For instance, with reference to UI display 400 of FIG. 4, the entity actions are displayed as a horizontal list, as shown by reference numerals 401, 402, and 403, and a selection of the entity action (“rent the movie #1”) 402 may display an abstract-object-based ad 430 (e.g., top-ranked ad selected by the spot auction). As illustrated, an interface element that represents the ad 430 may be placed within a sponsored zone on a pop-up window, which appears upon selecting the entity action 402. To distinguish the ad 430 interface element from the non-sponsored provider's interface elements (e.g., Blockbuster and Netflix), the ad 430 interface element may be labeled as “sponsored,” positioned proximate to bolded action text, provided with a heading text 210, and/or accompanied by a descriptive URL.

In one instance, the ad 430 interface element is selected for display upon the advertiser submitting the ad 430 winning a spot auction for the entity action “rent” in association with the entity class “movie” or in association with the entity “movie #1.” An interface element representing the ad 430 is then inserted into a predetermined sponsored zone allocated for ads within the pop-up window. If, upon insertion of the ad 430 interface element, vacant area remains within the sponsored zone, the next-ranked ad in the spot auction is selected as a candidate for insertion into the sponsored zone. It should be appreciated and understood that the ad 430 interface element, as well as the nonsponsored interface elements 410 and 420, are exemplary in number and may be organized in any logical manner within an area provided by the pop-up window.

Further, the interface elements 410, 420, and 430 may vary based on which of the entity actions 401, 402, and 403 are selected. In an exemplary embodiment, the nonsponsored interface elements that are displayed upon the user selecting either the “share” or “buy” entity actions 401 and 403 are related in some way to those entity actions 401 and 403 (e.g., links navigating to websites that prompt a user to share comments on movie #1 or buy tickets to see movie #1). In addition, the sponsored interface elements, or ads selected in the spot auction, that are displayed upon the user selecting either the “share” or “buy” entity actions 401 and 403 are selected because the winning advertisers targeted the entity actions “share” or “buy,” respectively. As such, in the embodiments of FIG. 4 discussed above, the sponsored and non-sponsored interface elements are selected and grouped based on relevance to a particular entity action.

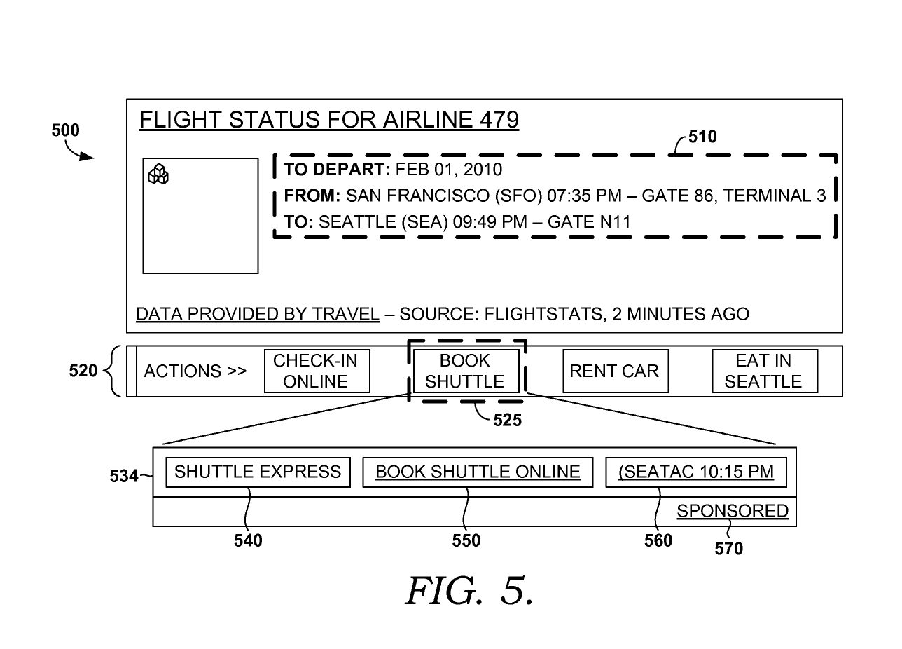

Turning now to FIG. 5, a UI display 500 is illustrated that shows a flight-state web page. The web page includes a header 510 that exposes information about the flight #479 and a horizontal list of entity actions 520 that are relevant to airline travel (e.g., check-in to flight, book shuttle from the airport, reserve a rental car in the destination city, and access a restaurant guide). Upon a user performing a hover action (e.g., mouse-over) directed to one of the interface elements representing a particular entity action, such as the “book shuttle” entity action 525, a compact hover box 534 may appear below the entity action 525 that includes sponsored and/or nonsponsored interface elements. As illustrated in FIG. 5, the hover box 534 includes interface elements 540, 550, and 560 pertaining to just a single sponsored advertiser, as indicated by the label “sponsored” 570.

In the absence of the sponsored label 570, the interface elements 540, 550, and 560 may be identified as originating from a sponsored advertiser by a variety of techniques, such as applying a different foreground color, background color, or some other highlighting element. It should be noted that abstract-object-based sponsored interface elements (ads) may be surfaced within the horizontal task bar holding the entity actions 520, or any other section within the web page that is proximate to or invoked by a targeted abstract object (e.g., entity action “book shuttle” 525) or intuitive to the user.

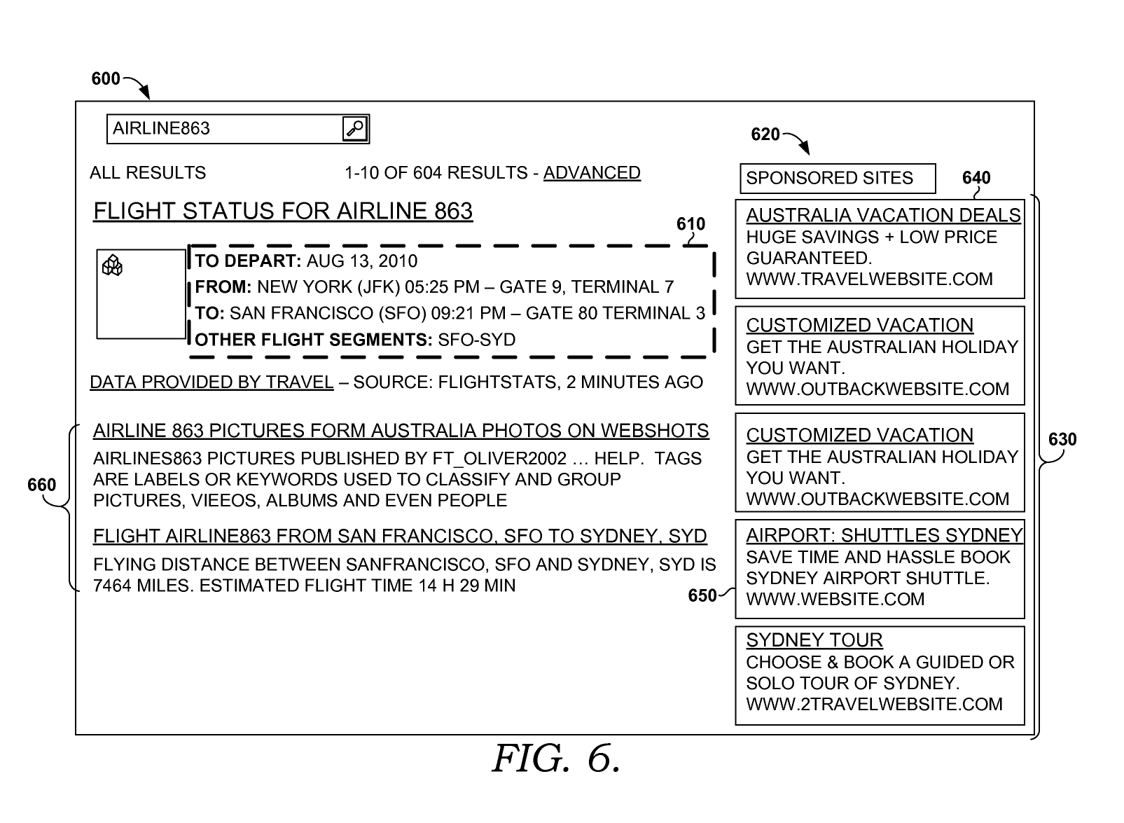

Referring to FIG. 6, a UI display 600 is illustrated that shows a flight-state search-results page that is rendered by the rendering component 356 of FIG. 3 in response to the search query “Airline 863.” The search-results page includes result item 610 that exposes information about the flight #863. The result item 610 may be rendered in various formats, such as a search result, an instant answer, etc. Additional result items 660 may be presented that also provide content that the search engine deems relevant to the search query. In a right-hand column 620, a set of ads 630 are presented on the search-results page that may target one or more of the following abstract objects: the entity of “flights from New York to Sydney, Australia,” the entity class of “travel,” or the task of “plan a trip.” As illustrated in the UI display 600, interface elements representing the ads 630 may be automatically (i.e., without user intervention) presented near the corresponding abstract objects or may be surfaced upon receiving a user indication (e.g., hover selector over entity, select entity, selection action, etc.) at predefined locations within the search-results page.

The ads 630 may be organized vertically based upon a ranking generated by the spot-auctioning component 355, where the highest-positioned ad 640 is submitted by the top-ranked advertiser. As illustrated, each of the ads 630 is sponsored (i.e., submitted by an advertiser when bidding at the search engine). Further, the ads 630 may be relevant to the abstract object that is the subject of the search-results page but not related to the search query in a keyword sense. For instance, if the subject abstract object of the search-results page is the entity “flights from New York to Sydney, Australia” and the search query is “Airline 863,” the top-ranked ads 630 may include the interface element 650 representing an ad for shuttles in Sydney and interface element 640 representing the ad for Australia vacation deals. These abstract-object-based ads hosted by the interface elements 640 and 650 are relevant to the subject abstract object and useful to the user (i.e., likely to receive a high frequency of click-through), as opposed to keyword-based ads that would have only known the phrase “Airline 863.”

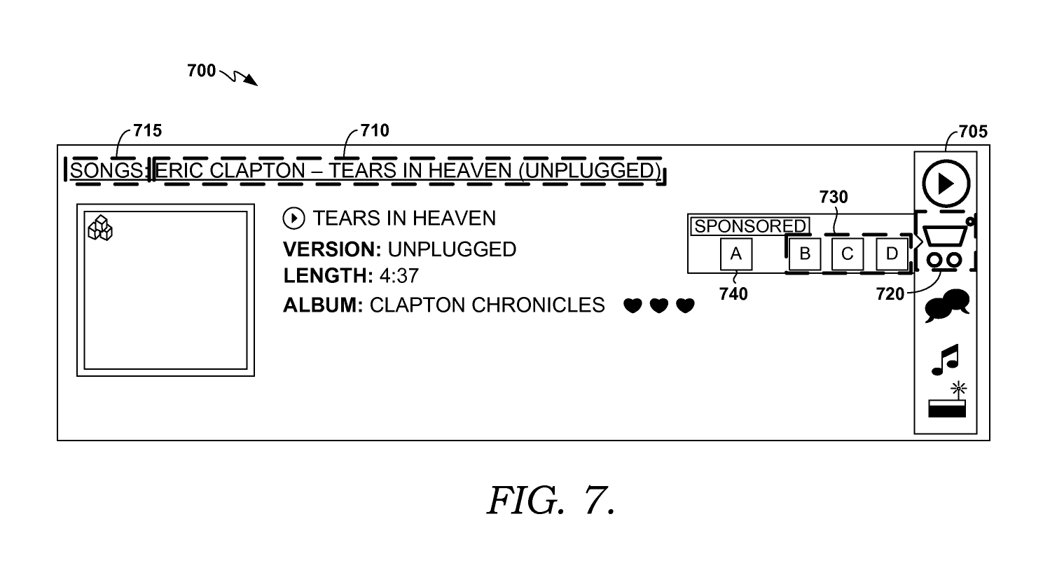

Referring to FIG. 7, a UI display 700 is illustrated that shows a web page that plays and/or sells music 715. In the web page illustrated in FIG. 7, the song “Tears in Heaven” is the subject entity, as indicated by the header 710. Or, the UI display 700 may be showing an instant answer within a search results page (not shown). A compact vertical task bar 705 along-side the instant answer represents available entity actions within the music domain. A hover window shown next to the “shopping cart” icon (representing the entity action 720 of “purchase the song”) displays providers that offer the subject entity for sale. A sponsored ad is represented by the interface element 740 and distinguished from the nonsponsored ads 730 by the label “sponsored” and by its positioning within the hover window (e.g., visible extended spacing with respect to the nonsponsored ads 730).

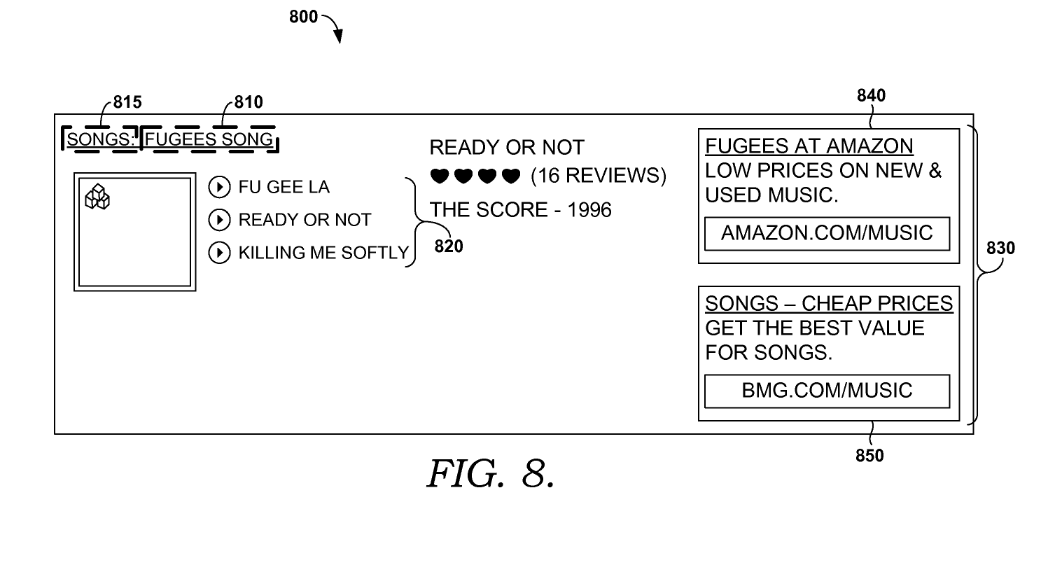

Referring to FIG. 8, a UI display 800 is illustrated that shows an instant answer that plays and/or sells music. In the web page illustrated in FIG. 8, songs 815 by the musical group “Fugees” is the subject entity class, as indicated by the header 810. Reference numeral 820 indicates the songs available to sample within the instant answer. A column 830 alongside the instant answer represents a provider zone allocated for holding ads. As illustrated in FIG. 8, both ads 840 and 850 are sponsored ads. Further, each of the ads 840 and 850, upon receiving a user-initiated selection action, navigate the user to a respective advertiser's website, thereby assisting the user in purchasing a song within the subject entity class.

Although various embodiments for distinguishing sponsored ads from non-sponsored ads have been described, it should be understood that other suitable indicators may be used to alert the user that some ads are submitted by sponsored advertisers while others are not. Further, in some instances, no distinguishing indicia is provided to set apart the sponsored ads (e.g., when all ads are from sponsored advertisers).

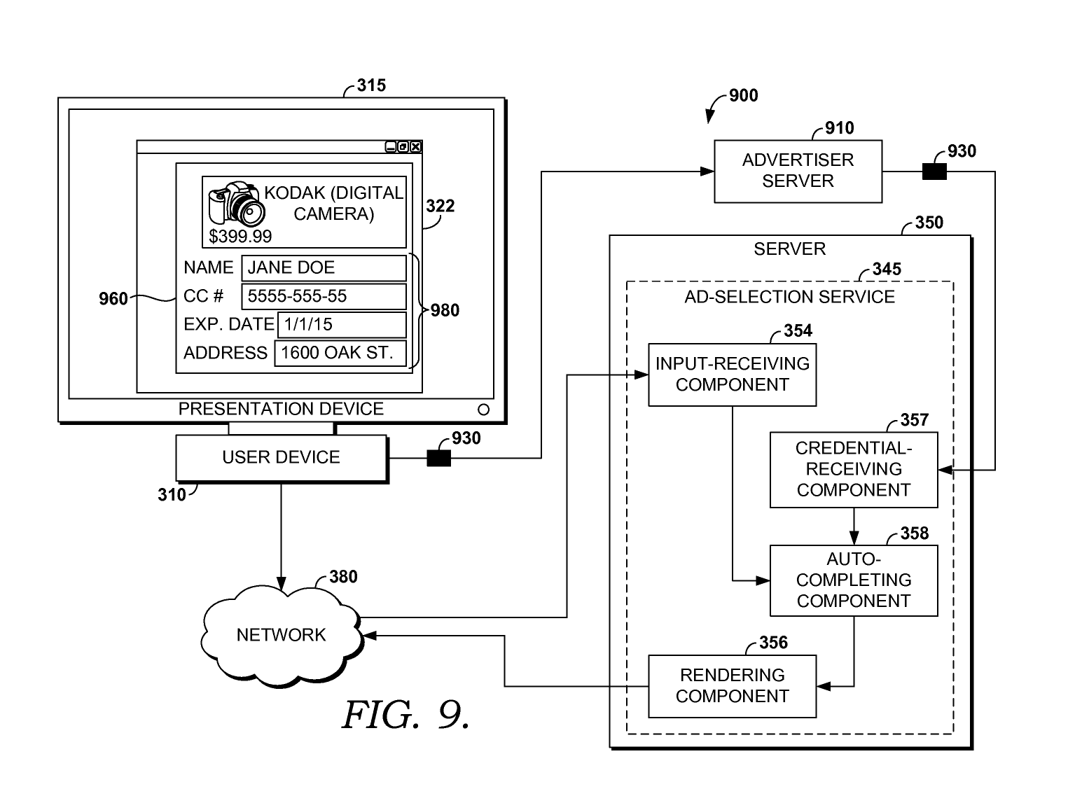

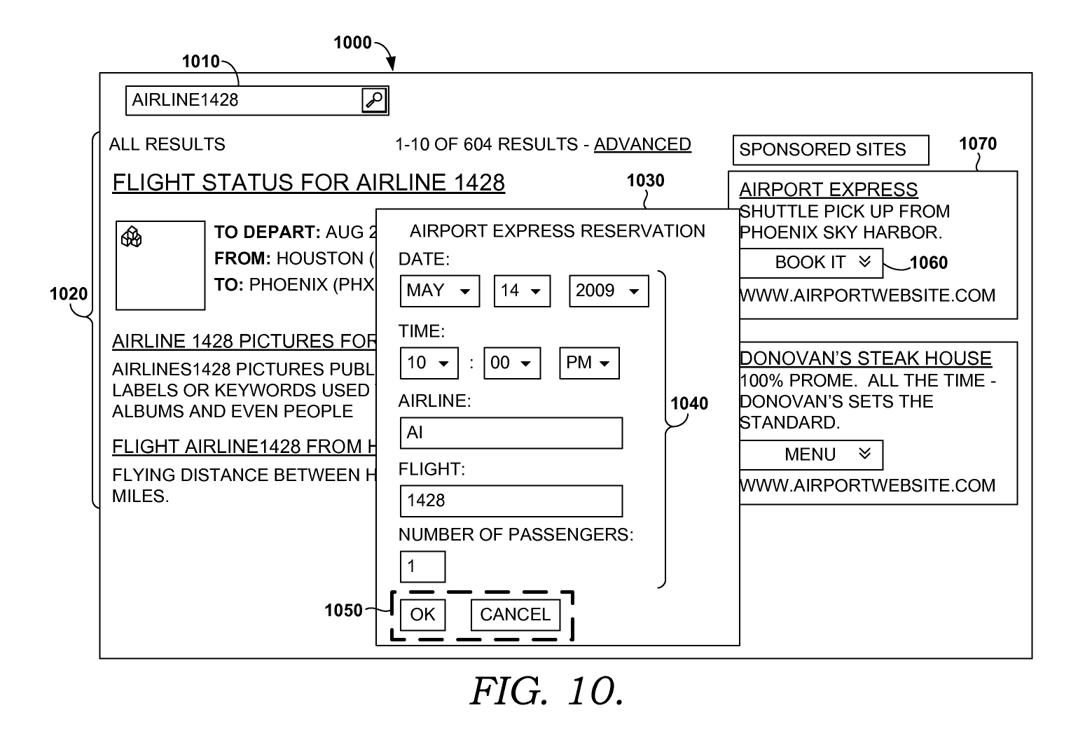

The system architecture for implementing the method of authentication sharing to improve user experience and abstract object targeting will now be discussed with reference to FIGS. 9 and 10. Initially, referring to FIG. 9, a block diagram is shown illustrating a distributed computing environment 900 suitable for use in implementing embodiments of the present invention. The exemplary computing environment 900 includes the user device 310, the server 350, an advertiser server 910, and the network 380 that interconnects each of these items. It should be noted that like components and devices are represented by like reference numerals, and that those components and devices described with reference to FIG. 3 will not be discussed again for the sake of clarity and conciseness.

The advertiser server 910, similar to the server 350, may take the form of various types of computing devices, such as, for example, the computing device 100 described above with reference to FIG. 1. Further, the server 910 includes, or is linked to, some form of a computing unit (e.g., central processing unit, microprocessor, etc.) to support operations of the component(s) running thereon. As shown, the advertiser server 910 represents a computing unit with a storage location remote from the server 350; however, in other embodiments, the advertiser server 910 and the server 350 may share resources.

In operation, the advertising server 910 is configured to store user information 930 that is entered by a user (e.g., utilizing the user device 310). In an exemplary embodiment, the user information 930 may include user credentials (e.g., login ID and password), personal data (e.g., address and phone number), financial accounts (e.g., credit card number, bank routing number, and the like), authentication data (e.g., name, date of birth, and social security number), and any other information a user may offer to an advertiser. This user information 930 may be accessed by a credential-receiving component 357, as discussed below.

In operation, the components 354, 357, 358, and 356 of the ad-selection service 345 are designed to perform an auto-completion process that employs the user information 930, as well as any other information accessible to the credential-receiving component 357, to fill in portions or complete an online form, as shown in FIG. 10. Initially, the input-receiving component 354 may detect a user-invoked entity action during a search event. The entity action may be any of the embodiments discussed above, including purchasing a product (e.g., Kodak digital camera) or reserving a shuttle (see FIG. 10). Further, the entity action may be located within the content of a web page (e.g., purchase button) or as a control 1060 within an interface element 1070 representing an ad. In one instance, upon a user navigating to a web page that sells cameras and that displays an abstract-object-based ad for purchasing a camera, the user may select an interface element representing the ad. In an exemplary embodiment, selection of the ad surfaces a predefined form 960 within the web browser 322 for completing the purchase. In one instance, referring to FIG. 9, surfacing the predefined form 960 involves redirecting the user to a check-out page for the particular entity (e.g., Kodak digital camera), where the check-out page is typically hosted by the advertiser's website. In another instance, referring to FIG. 10, surfacing the predefined form 1030 involves rendering the predefined form as a pop-up-type display area, where the display area is presented such that the predefined form 1030 may overlay content 1020 within the web page. In this instance, the predefined form 1030 is surfaced upon the user navigating to a web page displaying the interface element 1070 of the ad (e.g., submitted by an advertiser “Airport Express” shuttles) and the user electing to select the interface element 1070.

Upon presenting the predefined form 960 or 1030, the credential-receiving component 357 is configured to dynamically determine the identity of the user conducting the search event and to recognize the type of data being requested by the predefined form 960 or 1030. The credential-receiving component 357 may then interrogate the advertising server 910 with the user identity and the data type to retrieve the relevant user information for accurately completing the predefined form 960 or 1030, or a portion thereof. The relevant user information is then passed to the auto-completing component 358 for entry into the predefined form 960 or 1030.

Upon receipt of the relevant user information, the auto-completing component 358 enters the relevant user information into the predefined form 960 or 1030 in the entry locations 980 and 1040. In exemplary embodiments, the auto-completing component 358 enters the relevant user information into the predefined form 960 or 1030 by performing an auto-completion process comprising: accessing one or more predefined forms from the advertiser's website; and employing the ad-selection service 345 of the search engine to automatically complete at least a portion of the predefined form(s) with the user information.

In one instance, referring to FIG. 9, the auto-completing component 358 automatically populates the entry locations 980 of the predefined form 960 with the user's authentication information for purchasing a Kodak digital camera. In another instance, referring to FIG. 10, the auto-completing component 358 automatically populates the entry locations 1040 with data from the content 1020 of the web page. The rendering component 356 may then present the auto-completed entry locations 1040 for the user's review and approval.

Further, the predefined form 1030 may include selectable controls 1050 for submitting the predefined form 1030 (e.g., completing a reservation or purchase). By way of example, the selectable controls 1050 may be provided for approving a purchase of the particular entity (e.g., Kodak digital camera), where, upon approving the purchase, the customer's authentication information is used to secure payment for the particular entity. As such, the user is relieved from manually completing all or portions of a surfaced predefined form, facilitating the act of making an online purchase.

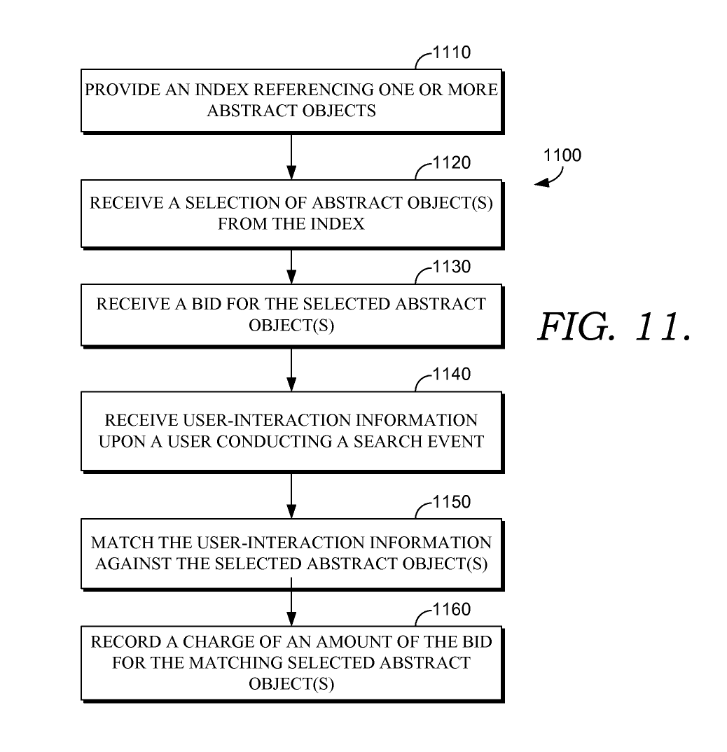

Turning now to FIG. 11, a flow diagram is shown depicting an illustrative method 1100 of monetizing abstract objects, in accordance with embodiments of the invention. Initially, as indicated at block 1110, the method 1100 involves the step of providing an index referencing one or more abstract objects. Typically, the abstract object(s) each describe a specific intent of a user when implementing a search event. As more fully discussed below, the specific intent may be distilled from a compilation of related user interactions with the search engine.

The method 1100 may further involve the steps of receiving a selection of abstract object(s) from the index (see block 1120), receiving a bid for the selected abstract object(s) (see block 1130), and receiving user-interaction information upon the user conducting the search event at the search engine (see block 1140). Generally, the user-interaction information includes query string(s), selection-action(s) within a UI, user-profile capturing historic search behavior of the user, and/or query log capturing historic search behavior of a plurality of users. Often, as indicated at block 1150, the user-interaction information is matched against the selected abstract object(s). As indicated at block 1160, an amount of the bid for the selected abstract object(s) that are matched is charged and the charged amount is recorded for purposes of billing.

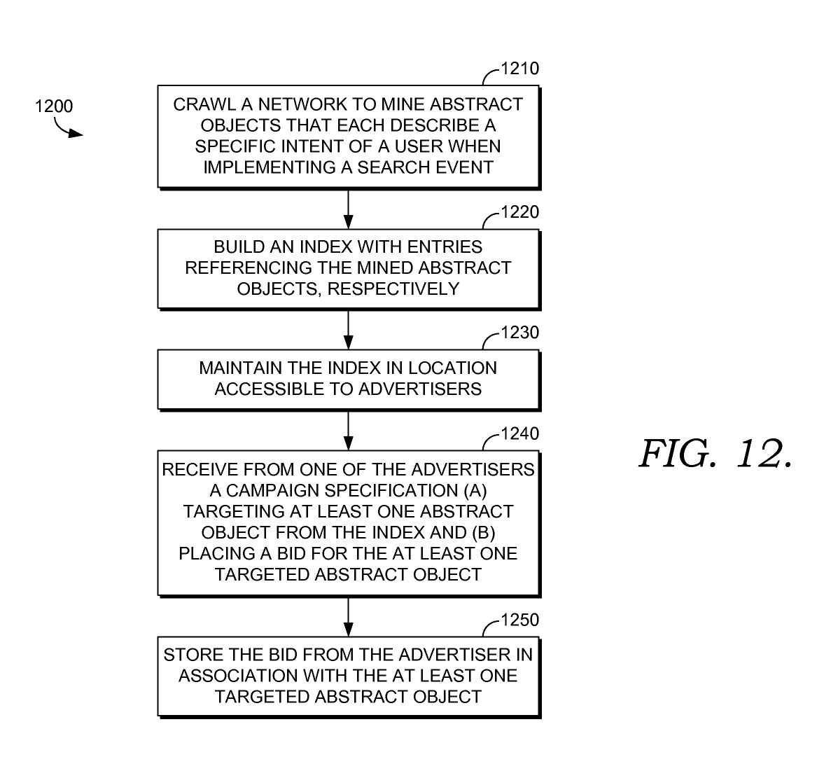

Referring to FIG. 12, a flow diagram is shown depicting illustrative method 1200 of allowing an advertiser to bid on an abstract object targeted thereby, in accordance with embodiments of the invention. In embodiments, the method 1200 involves the step of crawling a network to mine abstract object(s), as indicated at block 1210. The method 1200 may additionally involve the steps of building an index with entries referencing the abstract object(s) (see block 1220) and maintaining the index in a location accessible to advertisers (see block 1230). When the index is maintained in a location accessible to the advertisers, those advertisers are consequently allowed to view the entries on the index, target at least one abstract object from the index, and place a bid on the targeted abstract object as part of a campaign specification. Once the advertising campaign specification is received at a search engine, the search engine may store the bid in association with the targeted abstract object, as indicated at blocks 1240 and 1250.

Embodiments of the present invention may be described in the context of abstract-object-based advertising via a search engine. However, embodiments are equally applicable to other systems, such as mobile operating systems (e.g., mobile device 370) or other mobile scenarios (e.g., applets running on a mobile device). For example, a mobile-device applet may conduct a search event that results in several entities matching a scanned barcode or photographed object. Such a search may be monetized by applying the processes described above to generate interface elements for surfacing abstract-object-based ads. Another scenario covered by embodiments of the present invention relate to voice-activated desktop/mobile systems whereby, instead of conducting an online search event, the user issues complex commands in natural language such as “nearby Mexican restaurants open now.” The result of such a command may incorporate advertising directly through suggested actions (e.g., book one of a number of restaurants) or indirectly (e.g., display an ad for a taxi cab company next to results for booking a flight leaving from a nearby airport within the hour). Other user-issued commands may instruct a device to launch or install one of a number of applications from a large marketplace. In response, embodiments of the present invention may choose an application for launch or installation based on the comparison process (e.g., performed by the entity-matching component 353) and/or the ad-selection process (e.g., performed by the spot-auctioning component 355) described above.

Various embodiments of the invention have been described to be illustrative rather than restrictive. Alternative embodiments will become apparent from time to time without departing from the scope of embodiments of the inventions. It will be understood that certain features and subcombinations are of utility and may be employed without reference to other features and subcombinations. This is contemplated by and is within the scope of the claims.

The invention claimed is:

1. One or more computer-readable media having embodied thereon computer-executable instructions that, when executed, perform a method for allowing a first advertiser to bid on an abstract object targeted thereby, the method comprising:
providing an index in a location accessible to advertisers, thereby allowing the first advertiser to view the entries of the index, wherein the index includes entries referencing one or more abstract objects, wherein the one or more abstract objects each describe a specific intent of a user when implementing a search event, and wherein the specific intent is distilled from a compilation of related user interactions with a search engine;
receiving from the first advertiser a campaign specification targeting at least one abstract object from the index and placing a bid for the at least one targeted abstract object; and
storing the bid from the first advertiser in association with the at least one targeted abstract object.

2. The media of claim 1, wherein the one or more abstract objects include at least one of entities, entity classes, entity actions, and tasks.

3. The media of claim 2, wherein the entities each relate to a person, place or thing represented by a particular online description.

4. The media of claim 3, wherein the entity classes each relate to a set of the entities that share a common property.

5. The media of claim 4, wherein the entity actions each relate to one or more online actions the user performs via the user interactions with a search engine, and wherein the one or more online actions address an entity or an entity class.

6. The media of claim 5, wherein each of the tasks relate to a sequence of entity actions that are related by addressing the same entity or entity class.

7. The media of claim 1, the method further comprising:
receiving from a second advertiser a campaign specification targeting the at least one abstract object from the index and submitting a bid for the at least one targeted abstract object; and
storing the bid of the second advertiser in association with the at least one targeted abstract object.

8. The media of claim 7, the method further comprising:
receiving user-interaction information while the user is implementing the search event at the search engine, wherein the user-interaction information comprises at least one of a query string, a selection-action within a UI, a user-profile capturing historic search behavior of the user, or a query log capturing historic search behavior of a plurality of users; and
matching the user-interaction information against the at least one abstract object.

9. The media of claim 8, the method further comprising conducting a spot auction to select an ad to be displayed to the user.

10. The media of claim 9, wherein conducting the spot auction comprises:
accessing the bids that are stored in association with the at least one matched abstract object targeted by the first advertiser and the second advertiser; and
selecting an ad submitted by either the first advertiser or the second advertiser as a function of the bids received therefrom.

11. The media of claim 10, wherein selecting an ad submitted by either the first advertiser or the second advertiser as a function of the bids received therefrom comprises:
comparing a value of the bid received from the first advertiser and a value of the bid received from the second advertiser;
comparing a likelihood of click-through of a link received from the first advertiser and a likelihood of click-through of a link received from the second advertiser; and
comparing a quality of an ad received from the first advertiser and a quality of an ad received from the second advertiser.

12. A computer system for selecting an ad by employing and monetizing abstract objects, the computer system comprising a processing unit coupled to a computer-storage medium, the computer-storage medium having stored thereon a plurality of computer software components executable by the processing unit, the computer software components comprising:
a publishing component to publish an index at an online location, to allow advertisers to navigate the index and to bid upon one or more of the abstract objects therein, to receive bids in association with at least one ad submitted for display, and to temporarily store the bids in association with the at least one ad;
an entity-matching component to compile user interactions during a search event and to compare one or more of the compiled user interactions with the one or more abstract objects referenced by the index; and
a spot-auctioning component to select an ad associated with a bid received at the publishing component, wherein selecting the ad comprises:
(a) identifying an abstract object from the index that matches the one or more compiled user interactions upon comparison using the entity-matching component;
(b) identifying bids placed by one or more of the advertisers targeting the identified abstract object; and
(c) selecting the ad from a plurality of ads associated with the identified bids.

13. The system of claim 12, further comprising an input-receiving component to detect interactions of users when implementing search events at a search engine.

14. The system of claim 13, further comprising a web-crawling component to mine the abstract objects from a record of the user interactions with the input-receiving component, wherein the abstract objects each relate to a person, place, or thing represented by a particular online description, and to construct and maintain the index listing the mined abstract objects.

15. The system of claim 14, further comprising a rendering component for presenting the selected ad within a UI display based upon a visual arrangement of related abstract objects presented within the UI display.

16. A computerized method carried out by a search engine running on a processor for monetizing abstract objects during an online search event, the method comprising:
providing an index referencing one or more abstract objects, wherein the one or more abstract objects each describe a specific intent of a user when implementing a search event, and wherein the specific intent is distilled from a compilation of related user interactions with the search engine;
receiving a selection of at least one abstract object from the index;
receiving a bid for the at least one selected abstract object;
receiving user-interaction information upon the user conducting the search event at the search engine, wherein the user-interaction information comprises at least one of a query string, a selection-action within a UI, a user-profile capturing historic search behavior of the user, or a query log capturing historic search behavior of a plurality of users;
matching the user-interaction information against the at least one selected abstract object; and
recording a charge of an amount of the bid for the matched at least one selected abstract object.

17. The method of claim 16, wherein the one or more abstract objects include at least one of entities, entity classes, entity actions, and tasks.

18. The method of claim 16, further comprising:
accessing an ad for the at least one selected abstract object; and
facilitating presenting the ad to the user within the UI upon matching the user-interaction information against the at least one selected abstract object.

19. The method of claim 18, further comprising conducting a spot auction to select the ad to be displayed to the user.

20. The method of claim 18, further comprising storing the at least one selected object, the bid, and the ad in association with one another in a physical storage location accessible to the processor.
